(19) United States
(12) Patent Application Publication
(10) Pub. No.: US 2009/0034359 A1
(43) Pub. Date: Feb. 5, 2009

(54) STOPPED FLOW, QUENCHED FLOW AND CONTINUOUS FLOW REACTION METHOD AND APPARATUS

(75) Inventors: Caroline Cardonne, Santa Barbara, CA (US); Frederic Bottausci, Santa Barbara, CA (US); Carl D. Meinhart, Santa Barbara, CA (US); Igor Mezic, Goleta, CA (US)

Correspondence Address: GATES & COOPER LLP;HOWARD HUGHES CENTER, 6701 CENTER DRIVE WEST, SUITE 1050, LOS ANGELES, CA, 90045, US

(73) Assignee: THE REGENTS OF THE UNIVERSITY OF CALIFORNIA, Oakland, CA (US)

(21) Appl. No.: 12/098,087

(22) Filed: Apr. 4, 2008

Related U.S. Application Data
(60) Provisional application No. 60/910,154, filed on Apr. 4, 2007.

(51) Int. Cl. B01F 11/00; B01F 15/02; B01F 13/00

(52) U.S. Cl. 366/116; 366/154.1; 366/153.2

(57) ABSTRACT

Microscale or nanoscale apparatus for stopped-flow, quenched flow or continuous flow reaction apparatus where fluids or gases are mixed in a device composed of parallel or serial assembly of the basic fluid-containing cell having a longitudinal axis, a cross-sectional area generally perpendicular to the longitudinal axis, and at least one connected crossing cell having a longitudinal axis, a cross-sectional area generally perpendicular to said longitudinal axis and a fluid motivating force interacting transversally with the fluids flow.

### CROSS-REFERENCE TO RELATED APPLICATIONS

This application claims the benefit under 35 U.S.C. Section 119(e) of the following co-pending and commonly-assigned U.S. patent application:

U.S. Provisional Patent Application Ser. No. 60/910,154, filed on Apr. 4, 2007, by Caroline Cardonne, Frederic Bottausci, Carl Meinhart and Igor Mezic, entitled “STOPPED FLOW, QUENCHED FLOW AND CONTINUOUS FLOW REACTION METHOD AND APPARATUS,” attorneys docket number 30794.230-US-P1 (2005-040);

which application is incorporated by reference herein.

### BACKGROUND OF THE INVENTION

1. Field of the Invention

The present invention relates to stopped flow, continuous flow and quenched flow apparatus, and processes or methods for making the same. More particularly, the present invention relates to performing stopped flow, continuous flow or quenched flow experiments by mixing the solutions under low pressure and non-turbulent conditions.

2. Description of the Related Art

(Note: This application references a number of different publications as indicated throughout the specification by one or more reference numbers within brackets, e.g., [x]. A list of these different publications ordered according to these reference numbers can be found below in the section entitled “References.” Each of these publications is incorporated by reference herein.)

Understanding the structure, the thermodynamic and kinetic properties of protein folding is crucial for comprehending the origin of a wide range of diseases. Many diseases appear to be the result of incomplete or misfolding of proteins. Folding and unfolding are the ultimate ways of generating and abolishing specific types of cellular activities [1]. Proteins that fail to fold correctly, or fail to remain correctly folded, might therefore give rise to malfunctioning living systems and hence to possible development of diseases [2-5, 6], like cystic fibrosis [5], or some types of cancer [7]. Misfolded proteins can also aggregate, which can result in several other diseases [10], like the Prion disease (Creutzfieldt-Jacob) [2, 8, 9], Alzheimer's [3] or Parkinson's disease [4].

Recently, several studies have been extended to structural investigations of larger biological assemblies, such as RNA (folding) [11], viruses (conformational changes) [11], or globular complexes (crystallization) [12].

The study of the kinetics of proteins is achieved by rapidly mixing the biological molecules with reactants. In contact with the chemicals, the unfolded proteins start to fold. Folding can be a very fast process. Protein folding, for example, can occur in a very short time, ranging from a few hundreds of nanoseconds to hundreds of milliseconds [13, 14, 15]. It is then essential to achieve a homogeneous mixing in a minimum amount of time in order to get reliable information from the start of the folding process. The purpose is to understand the reason for incomplete folding and misfolding of proteins. Mixing is thus a key component that has to be performed by one of the devices used in the process. Widely used mixing processes generally involve turbulence. The mixing is then achieved by combining different high velocity jets in order to achieve turbulent flows and rapid mixing.

The time resolution of a fast mixing device is determined by the instrumental dead time, which depends critically on the time required to achieve complete mixing of the two reagents (mixing time), the flow velocity, and the volume between the mixing region and the point of observation (dead volume).

To capture the thermodynamic and kinetic behavior of organic or inorganic compounds, several methods are used.

Stopped-flow mixing techniques, originally developed in 1940 by Chance [16], have been widely used to induce rapid changes in concentration and trigger chemical reactions, thus getting real time information. These techniques use a reactor to rapidly mix together compounds which then react to form a new product. The main purpose of that technology is to study the formation of the product from the early stage on. The product then flows into an observation cell. A stop syringe is used to limit the volume of solution within the cell by abruptly stopping the flow. The product is then analyzed using optical properties and techniques (absorbance, fluorescence, light scattering, spectroscopic technique, etc.). The measurement of these optical properties is performed by system detectors which can be mounted either perpendicular or parallel to the path of incoming light. The technique has applications in several domains, including protein and macromolecule folding and unfolding [17, 18] or polymerization [19]. For instance, protein unfolding and refolding pathways have been extensively studied using fluorescence intensity [15, 20], circular dichroïsm [21], relaxation dispersion nuclear magnetic resonance [22], microcalorimetry [23], X-ray absorption spectroscopy [24], and scattering techniques [25]. The time resolution is often of the order of milliseconds or lower [6].

Chemical quench-flow is another method for studying the thermodynamic and kinetic behavior of organic or inorganic compounds [26, 27]. It allows direct measurement of the conversion of compounds into product. A basic chemical quench-flow allows the mixing of two reactants, followed (after a specified time interval) by quenching with a chemical agent (usually acid or base) [28]. The quenched sample is then collected and analyzed to quantify the conversion to product (usually the compounds are labeled and the product formation is determined by either gel electrophoresis or standard chromatography methods). The duration of the reaction is determined by the time given to the product to evolve before mixing it with the quenching chemical.

Shastry et al. [29] have published a study on protein folding using a continuous flow mixing device. In that case, two (or more) compounds are rapidly mixed in a reactor. The product then flows in a transparent cell where it can be analyzed using the detection techniques mentioned previously. The evolution of the reaction occurs continuously while the product flows downstream (away from the mixer and along the flow direction). This can be translated into time knowing the flow rate and the dimensions of the flow channel.

Rapid mixing in the techniques mentioned above is generally achieved through turbulent fluctuations. High pressure syringes are used to inject the compounds into the mixing cell with high velocities in order to create a turbulent flow. As the compounds are mixing, they are experiencing strong shear coming from the turbulent fluctuations and the high velocity confined flow. More recently, in order to reduce the volume of solution used for the study, the channels became smaller. Under these circumstances, the viscous effects become dominant and turbulence cannot be easily generated anymore.

Over the past decades, the study of microfluidic micromixers enabled more efficient mixing through passive mixers [35, 38] or active mixers [36, 37, 39]. Laminar microfluidic mixers might be a solution to this problem [1, 7]. The use of such devices allows small volume consumption and enables rapid mixing with low shear rates and low costs.

What is needed are improved methods and apparatuses for efficient, rapid, accurate and low-cost mixing of small amounts of compounds (e.g., proteins, DNA, RNA, molecules) using fluid flow manipulations. The present invention satisfies that need, especially when applied to stopped-flow, quenched flow and continuous flow analysis.

### BRIEF DESCRIPTION OF THE DRAWINGS

Referring now to the drawings in which like reference numbers represent corresponding parts throughout:

FIG. 1 is a block diagram of the basic cell microfluidic system, wherein FIG. 1(a) is a top view of the micromixer, and FIG. 1(b) is a schematic diagram of the microfluidic system (pumps, syringes and manifold) and connections.

FIG. 2 is a picture of the mixing channel crossing by two pairs of side channels (the basic cell), wherein the second pair is activated, fluids are flowing from left to right, amplitude and frequency are optimized, the Reynolds number is Re=2.6 and the flow rate is fixed at 277 pl/s.

FIG. 3(a) (left) shows the Mixing Variance Coefficient (MVC) for the particles solution with diffusivity Dₚₛ=2.2 μm²/s, wherein good mixing is achieved for low value of the MVC, complete mixing is achieved in 10 ms over 200 microns in the region of high frequency and amplitude, and FIG. 3(b) (right) is a block of three pictures showing the flow in the main channel after mixing corresponding to three sets of parameters (Amplitude, Frequency) of oscillation (1,2 and 3).

FIG. 4 (a) is an experimental velocity field at the intersection of the mixing channel and the side channel, as a function of position in the intersection, after a quarter of a period and FIG. 4 (b) is a computed velocity field under the same conditions, where amplitude and frequency are respectively Â=2.15 and \hat{f}=2.2.

FIG. 5 (a) is a picture of the flow in one of the transverse channels, after a few oscillations, where fluids are mixed by Taylor-Aris dispersion, and FIG. 5 (b) is a picture of the flow in the main channel where mixed fluids are injected from the side channel.

FIG. 6 is a schematic of a micromixer device, comprising one pair of transverse channels perpendicular to the mixing chamber and two injection channels from which the fluid(s) to be mixed are injected, wherein in each pair the flow oscillates to create structures in the main channel, and a valve at the end of the main channel enables the flow to be stopped.

FIG. 7 is a schematic of a micromixer configuration comprising four injection channels, three micromixers, and a valve, wherein a product is formed in parallel using the micromixers A and B and then these products (from A and B) can be mixed together using the micromixer C, and the valve at the end of the main channel enables the flow to be stopped.

FIG. 8 is a schematic of a micromixer configuration comprising three injection channels, two micromixers, and a valve, wherein a product is formed using the micromixer A, then this product can be mixed together with another reactant using the micromixer B, and the valve at the end of the main channel enables the flow to be stopped.

FIG. 9 is a schematic of a micromixer configuration comprising five injection channels, one micromixer, and a valve, wherein a product is formed by mixing simultaneously the five reactants, and the valve at the end of the main channel enables the flow to be stopped.

### SUMMARY OF THE INVENTION

The present invention discloses a device where stopped flow, continuous flow and quenched flow experiments are performed under low pressure, non-turbulent conditions. The device includes an active mixer capable of mixing under laminar flow conditions. Stopped flow experiments may be performed in parallel under the low pressure, non-turbulent conditions.

The present invention also discloses a process where two or more reactants are brought together in a device to perform stopped flow, continuous flow and quenched flow experiments under low pressure, non-turbulent conditions.

The present invention also discloses a process where ELISA assay is performed using a microchannel mixing setup.

The present invention discloses a process where cDNA experiments are performed using a microchannel mixing setup.

An apparatus for mixing two or more fluids in accordance with the present invention comprises a fluid containing cell for containing two or more main fluid flows, and at least one side cell for introducing a secondary fluid flow into the fluid containing cell at an intersection between the side cell and the fluid containing cell, wherein the secondary fluid flow perturbs the main fluid flows in the fluid containing cell and introduces recirculating motion in the fluid containing cell.

Such an apparatus further optionally comprises the two or more fluids introduced into the fluid containing cell upstream of the intersection are not mixed, the secondary fluid flow creates a mixing of the two or more fluids, and two or more fluids are fully mixed downstream of the intersection, the secondary fluid flow being an oscillatory flow resulting from fluid motion oscillations at specific amplitudes and frequencies driven in the side cell which perturbs the two or more main fluid flows in the fluid containing cell to enhance the mixing of the two or more fluids in the fluid containing cell, the mixing being under laminar flow conditions, the apparatus being a laminar flow mixer for one or more of the following applications: stopped flow mixing, quenched flow mixing, continuous flow mixing, ELISA testing, c-DNA experimentation, and Kinase-based assays, there being a pair of side cells, the side cell being perpendicular to the fluid containing cell, a secondary fluid in the secondary fluid flow being identical to one of the fluids, and a secondary fluid in the secondary fluid flow being a mixture of the fluids.

A method in accordance with the present invention comprises perturbing two or more fluid flows with one or more oscillating side flows, wherein the oscillating side flow causes the two or more fluid flows to homogeneously mix under laminar conditions and within 100 milliseconds.

Such a method further optionally comprises the oscillating side flow creating recurrent circulating flows within the two or more fluid flows, the oscillating side flow being a jet flow having a frequency and amplitude of oscillation which enhances mixing by creating vortices, which in turn create multiple fluid layers, and Taylor-Aris dispersion in the two or more fluids flows, the mixing being used to perform one or more of the following: stopped flow analysis, quenched flow analysis or continuous flow analysis, the method being used to perform ELISA testing or c-DNA experimentation, the mixing being fast enough to observe protein folding and unfolding, and a device for implementing the method.

Another apparatus for mixing two or more fluids in accordance with the present invention comprises a main channel for containing a first fluid stream of a first fluid and a second fluid stream of a second fluid, in the main channel, and a secondary channel for introducing a transverse oscillating jet flow into the main channel at an intersection between the secondary channel and the main channel, wherein the intersection provides an intersection for the first fluid stream, second fluid stream, and the transverse oscillating jet flow, a first inlet to the main channel, upstream of the intersection, for introducing the first fluid into the main channel, a second inlet to the main channel, upstream of the intersection, for introducing the second fluid into the main channel, and an outlet for the main channel, downstream of the intersection.

Such an apparatus further optionally comprises the main channel having a length which is at least ten times h where h=100 μm, the dimensions of the secondary channel being chosen so that flow in the secondary channel has a Reynolds number greater than 11, and the transverse oscillating jet flow has an amplitude and frequency of oscillation causing a mixing variance coefficient less than 0.02.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

Overview

The mechanism of the rapid laminar mixing of fluids induced by transversal jet flows is described numerically and experimentally herein. By means of a simplified model, namely, a microfluidic device comprised of a main channel (mixing cell) and transversal channels, it is shown that jet flows induce the formation of a recirculation region providing a dynamical mechanism to produce rapid and efficient mixing. The numerically predicted dynamical phenomenon is demonstrated experimentally.

An exemplary application of this invention would be to mix a protein (e.g. cytochrome C) and a basic or acid buffer, to analyze its folding or unfolding structure and kinetic behavior. Current methods require turbulent mixing and are generally high compound consuming. Another use might be to analyze the polymerization of molecules like ethene or propene. Another use might be to study the RNA folding.

The present invention comprises a device that can produce mixing under laminar conditions for applications in stopped flow, continuous flow and quenched flow analysis. The present invention also comprises a method that can produce mixing under laminar conditions where the manipulation of the fluids to achieve mixing is done by the action of the jet flow coming from one or more transverse cells. The present invention also comprises a process that can produce mixing under laminar conditions where a least one solution resulting from the mixing of reagents has been created.

Technical Description

This disclosure first introduces an apparatus and a procedure where two fluids are introduced, then mixed, in a micromixer device. The micromixing produced by a microfluidic device comprises of a main fluid containing cell (main channel) and a pair of transverse channels. Jet flows resulting from the oscillations in the transverse channels perturb the main stream to create vortices and generate an efficient mixing.

The design of the mixer is composed of a main channel where the fluids are injected, and one or more transversal channels to manipulate the fluids and increase the mixing [31, 32, 36, 37].

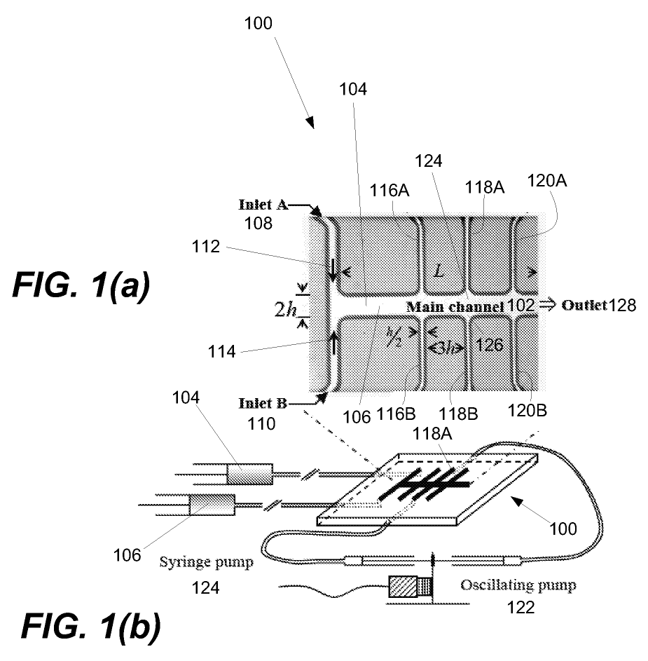

An example of the basic cell mixing device 100 design is shown FIG. 1(a) and FIG. 1(b). FIG. 1(a) is a top view of the 16 mm by 16 mm mixing device 100 microfabricated using conventional techniques. The device 100 was deep reactive ion etched in silicon, and anodically bonded to a cover glass. The mixing device 100 consists of a main channel 102 where the two fluids 104, 106 to be mixed are injected at Inlet A 108 and Inlet B 110. The two fluid streams 112, 114 move from left to right in the main channel 102. Three pairs of secondary channels (116A, 116B), (118A, 118B) and (120A, 120B) are positioned perpendicular to the main channel 102. The fluid motion in these secondary channels (116A, 116B), (118A, 118B) and (120A, 120B) is driven at specified amplitudes and frequencies, and perturbs the flow field in the main channel 102 to enhance mixing. In the present study only the central pair of secondary channels (118A, 118B) is activated. The main channel 102 is 2h wide and L=13.5h long. The secondary side channels 116(A,B), 118(A,B) and 120(A,B) are h/2 wide, 5h long and separated from each other by a distance of 3h. The depth of the channels 102, (116A, 116B), (118A, 118B) and (120A, 120B) is h where h=100 μm.

The flow in the secondary channels 118(A,B) is driven by high-frequency oscillating syringe pumps 122 (FIG. 1(b)) and a syringe pump 124 injects the two fluids 104, 106 to be mixed into the device 100 (FIG. 1(b)).

Two fluids 104, 106 are injected in the device 100 through inlet A 108 and B 110 (FIG. 1) at steady and constant flow rate. The flow 112, 114 is fully developed when reaching the intersection 124 of the side channels 118(A,B) [31]. The fluids 104, 106 are then manipulated by the transverse oscillating jet flow. The velocity condition V_{SC}=V₀ sin(ωt) is imposed at the entrance 126 of the side channels 118(A,B). The Reynolds number associated with the secondary channel flow is defined as

$${Re}_{SC} = Afb / v , \\ where$$

$$A = {\int }_{0}^{1 / 2 f} {V}_{SC} ( t ) d t$$

and b=50 μm is the secondary channel width. The present invention makes the various flow parameters non-dimensional, thereby obtaining a non-dimensional amplitude Â=A/a, frequency

\hat{f}=f_{ab}/v

and velocity

\hat{v}=Vᵥ/Aab'

where a=2h is the chamber 102 width and b=h/2 the side channel 118A, B width. The unsteadiness in the flow in the secondary channels is described by the Strouhal Number,

St=fh/U'

where f is the oscillation frequency and U is the flow velocity.

The main flow consists of two unmixed, miscible fluids 104, 106 entering the chamber 102. The working fluids are degassed and deionized water. In order to distinguish the two fluid streams 112, 114, one stream was seeded with 98 nm dia. fluorescent polystyrene particles, with a diffusion coefficient of Dₚₛ=2.2 μm²/s. As they enter the mixing chamber, the interface is clear and only a slight amount of mixing occurs due to molecular diffusion (diffusion length is calculated to be 0.7 μm). When the side channels 118(A,B) are activated for Re_{SC} above the threshold of 11, the two fluid streams (or flows) 112, 114 (which are not mixed just before the intersection 124) are manipulated by the transverse flow from the side channels 118(A,B) and become fully mixed downstream of the intersection 124. Also shown is the outlet 128 of the device 100. A similar analysis applies to activation of additional side channels 116(A,B) and 120(A,B).

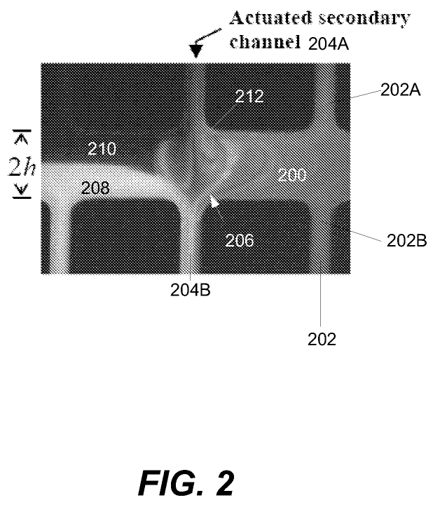

FIG. 2 is a picture of a basic cell comprising the mixing channel 200 crossing by two pairs of side (secondary) channels (202A, 202B) and (204A, 204B), wherein the second pair (204A, 204B) is activated, fluids are flowing from left to right, amplitude and frequency are optimized, the Reynolds number is Re=2.6 and the flow rate is fixed at 277 pl/s (picoliters per second).

FIG. 2 is an instantaneous snapshot (top view) of the mixing performance for optimized frequency and amplitude. As the fluids approach the intersection 206 from the left, two well discernible bands 208, 210 of fluid are visible, and within about 100 microns downstream of the intersection 206 the fluids are thoroughly mixed.

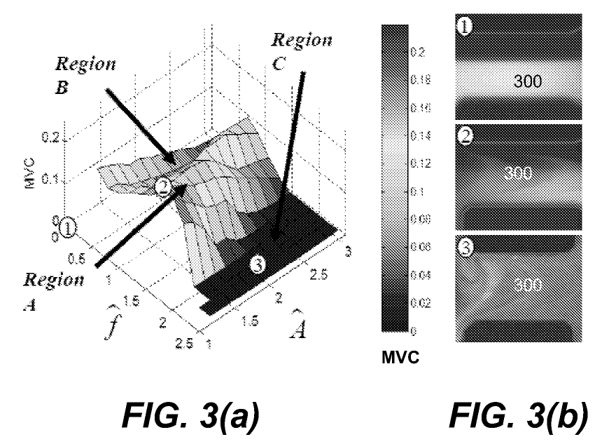

The degree of mixing can be quantified by the so-called Mixing Variance Coefficient function Φ (MVC) [31-33]. Complete mixing is achieved when Φ=0 and no mixing corresponds to Φ=0.25. The optimum amplitude and frequency of the secondary channel oscillations were determined systematically by measuring the MVC as a function of non-dimensional frequency 0<\hat{f}<2.5 and amplitude 1<Â<3. FIG. 3(a) shows the MVC as a function of \hat{f} and Â. In Region C, where high frequencies and amplitudes are achieved, the mixing is excellent (MVC˜0.01). FIG. 3(b) is a block of three pictures 1, 2 and 3, showing the flow (MVC) at the same location in the main channel 300 after mixing corresponding to the three sets of parameters (Amplitude, Frequency) of oscillation 1,2 and 3 marked in FIG. 3(a).

In order to improve the present invention's understanding of the mixing mechanism, the present invention examines the fluid motion and scalar fields at the intersection of the secondary channel and the main channel.

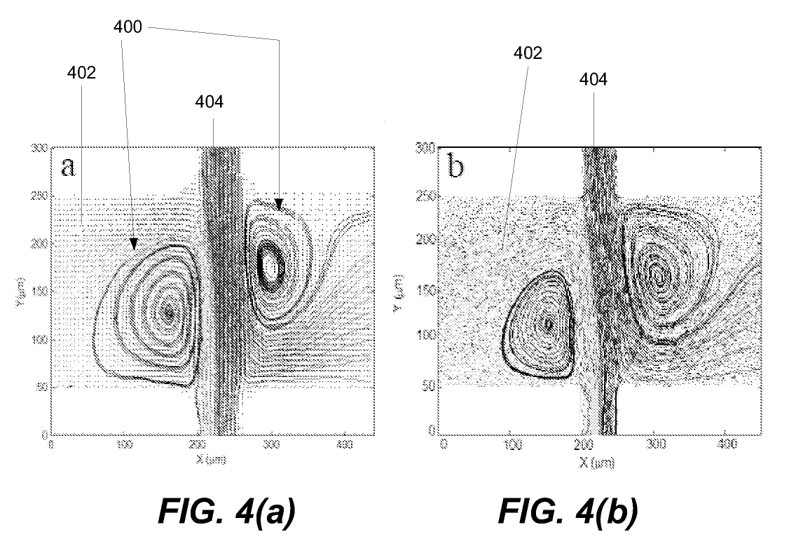

The secondary channels 204A, 204B are perpendicular to the main channel 200 and have sharp corners 212. This creates a sudden expansion for flow being injected into the main channel 200 from the secondary channels 204A and 204B as shown in FIG. 2. For sufficiently large Reynolds numbers, Re_{SC}>11, nonlinear effects are prominent at the intersection 206 and two recirculation vortices 400 appear (see FIGS. 2 and 4).

FIG. 4(a) is an instantaneous snapshot of the velocity field at the intersection of the mixing channel 402 and the side channel 404, after a quarter of a period of oscillation, obtained by micro Particle Image Velocimetry [34] (μPIV), and FIG. 4(b) is a direct numerical simulation of the flow for the same configuration and conditions using Fluent™ (Lebanon, N H) (see Bottausci et al. [31] for details).

The vortices develop and grow as the flow velocity reaches its maximum velocity in the side channel (data not shown). As the jet flow slows down, the recirculation does not stay symmetrical, because of the influence of the velocity in the main channel, U. The vortices vanish just after the velocity in the secondary channels reaches zero.

The mixing process is a combination of two factors:

1) The vortices creating multiple layers of fluids.

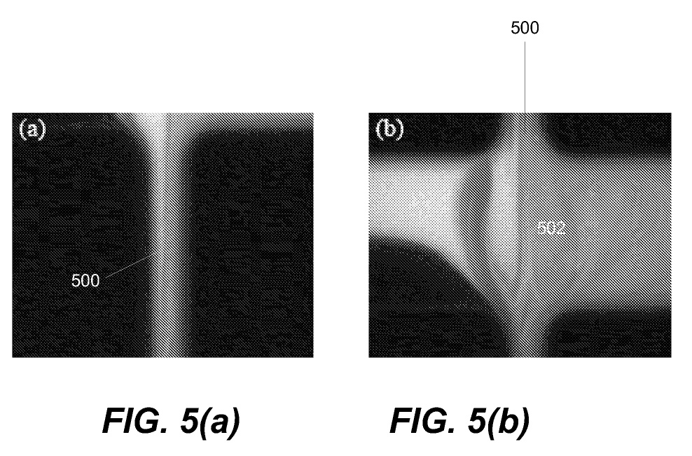

2) The Taylor-Aris dispersion taking place mainly in the side channels 500, FIG. 5(a), but also in the main channel 502 (FIG. 5(b)). FIG. 5(a) is a picture of the flow in one of the transverse channels 500, after few oscillations, where fluids are mixed by Taylor-Aris dispersion, and FIG. 5(b) is a picture of the flow in the main channel 502 where mixed fluids are injected from the side channel 500.

The layers entering the side channel are stretched, due to the contraction of the secondary channel. Inside the secondary channels, there is significant Taylor-Aris dispersion due to high shear rates, which further enhances the mixing process. Every half cycle, mixed fluid coming from the side channel is injected in the main channel.

Depending on the applications, a valve can be added at the end of the main channel to rapidly stop the flow. The valve can be, for example, a mechanical valve (piezohydraulic, pneumatic and thermopneumatic or pressure driven), or a multiphase valve (bubble valve or two phase flow where the flow is suddenly stopped by freezing a section of the main channel).

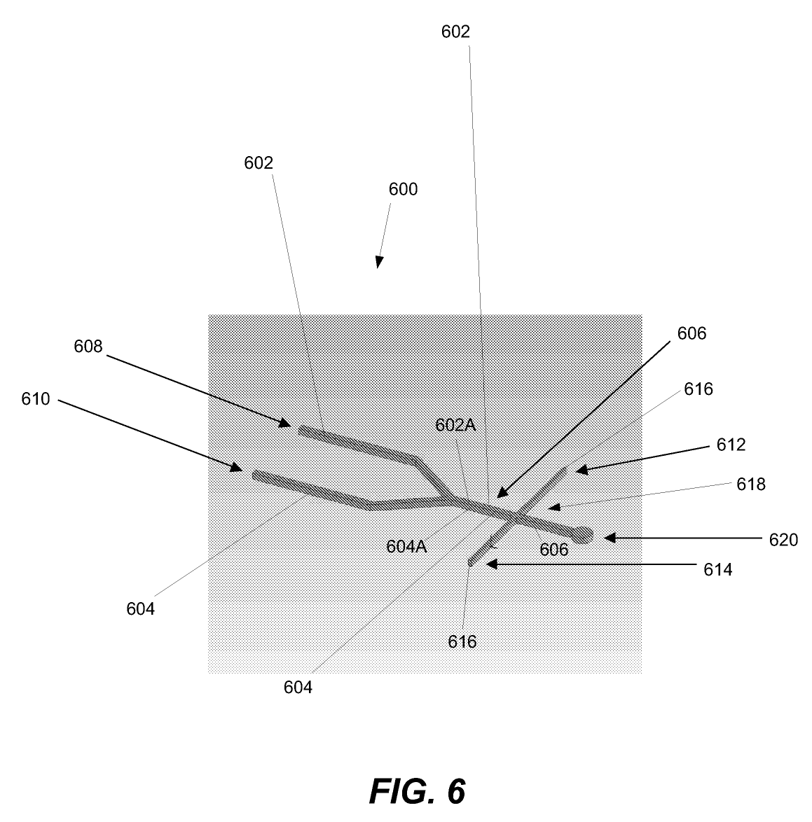

FIG. 6 illustrates a mixing apparatus 600 (micromixer device) for mixing two or more fluids (602, 604), comprising a fluid containing cell 606 (or main channel), injection channels 608, 610 for injecting two or more main fluid flows 602A, 604A (of fluids 602 and 604, respectively) into the fluid containing cell 606, a pair of side cells 612, 614 for introducing a secondary fluid flow 616 into the fluid containing cell 606 at an intersection 618 between the side cells 612, 614 and the fluid containing cell 606, and a valve 620 at the end of the main channel 606 enabling flow to be stopped. Upstream of the intersection 618, fluids 602 and 604 are unmixed. The secondary fluid flow 616, which oscillates, perturbs the main fluid flows 602A, 604A in the fluid containing cell 606 (to create structures in the flows 602A, 604A, leading to a mixing of the flows 602A, 604A) so that downstream of the intersection 618, the fluids flows 602A, 604A are fully mixed.

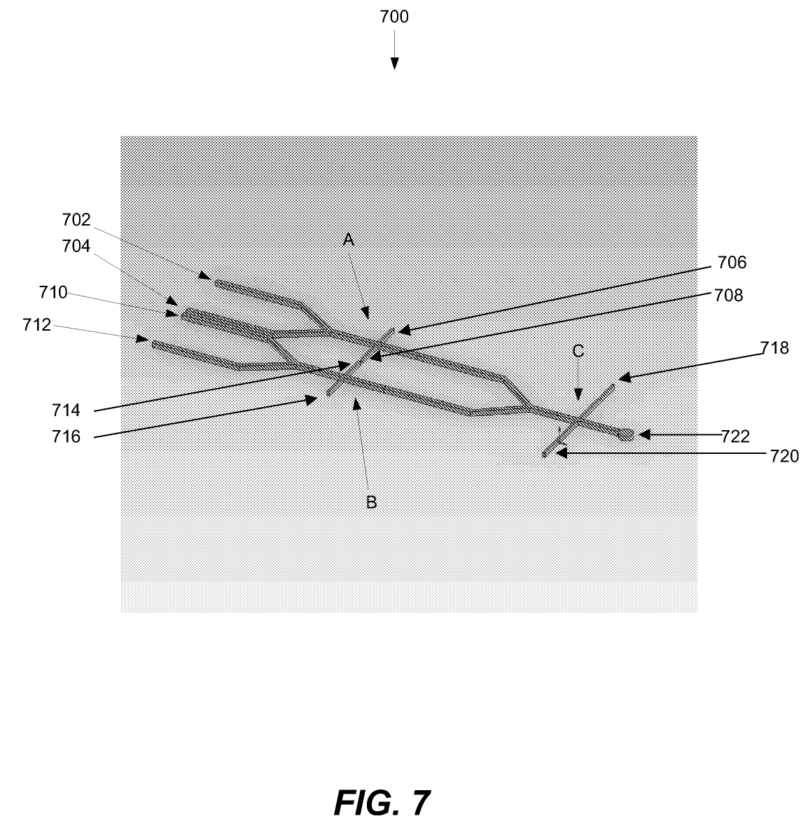

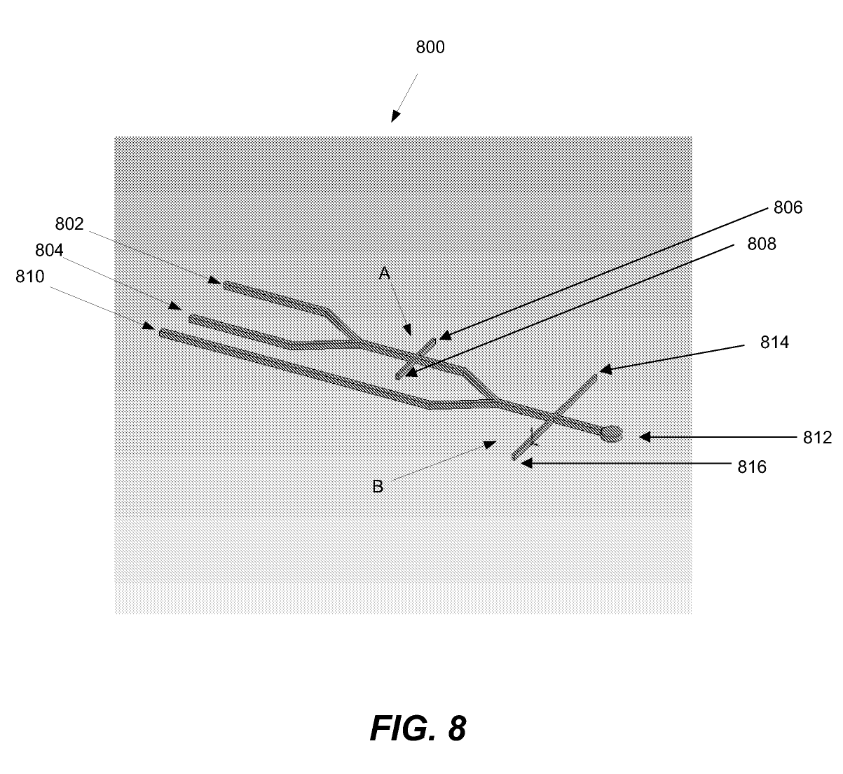

The mixing process and apparatus described here constitute an efficient and rapid micromixer that can be viewed as a module to be incorporated in already existing or to-be-developed apparatuses. This work opens the door to more sophisticated hydrodynamic behavior and apparatus design for micromixing applied to stopped flow, quenched flow or continuous flow apparatuses. Specifically, the basic unit described above can be operated in parallel to provide for multiple reactions where a specified cascade of reactions is to occur, such as in experimental studies of gene regulatory networks. Examples of such operation are provided in FIGS. 7 and 8.

FIG. 7 is a schematic of a micromixer configuration 700 comprising three mixing apparatuses A, B and C, wherein micromixer A has two injection channels 702, 704 and a pair of transverse channels 706, 708 for oscillations, micromixer B has injection channels 710, 712 and a pair of transverse channels 714, 716, micromixer C has transverse channels 718, 720, a product is formed in parallel using the micromixers A and B mounted in parallel and then these products (from A and B) can be mixed together using the micromixer C mounted in series with micromixers A and B, and the valve 722 enables the flow to be stopped.

FIG. 8 is a schematic of a micromixer configuration 800 comprising two mixing apparatuses A and B mounted in series, wherein micromixer A has injection channels 802, 804 and transverse channels 806, 808, wherein a product is formed using the micromixer A, then this product can be mixed together with another reactant (introduced in injection channel 810) using the micromixer B mounted in series with micromixer A, and the valve 812 at the end of micromixer B enables the flow to be stopped. Micromixer B has transverse channels 814 and 816 for oscillations.

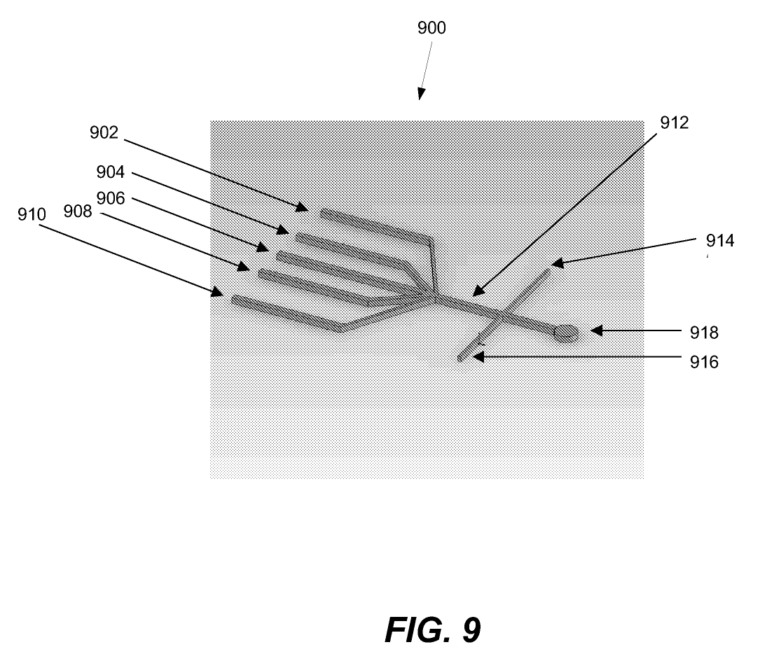

In addition, simultaneous reactions of multiple species can be pursued using the invention embodiment shown in FIG. 9. FIG. 9 is a schematic of a mixing apparatus 900 comprising five injection channels 902, 904, 906, 908, 910, a main channel 912 and a pair of transverse channels 914 and 916 for oscillations, wherein a product is formed by mixing simultaneously the five reactants inputted through the injection channels 902-910 and the valve 918 at the end of the main channel 912 enables the flow to be stopped.

This invention thus introduces a method of mixing and a device, that can produce mixing under laminar conditions for applications in stopped flow, continuous flow and quenched flow analysis. Additionally, designs utilizing the basic cell to operate in parallel with other such cells can be used to perform c-DNA experimentation and ELISA testing, as well as Kinase-based assays.

Possible Modifications and Variations

The fluid containing cell and side cells may be channels having a longitudinal axis and a cross-sectional area, wherein the fluid flows generally along the longitudinal axis. The fluid-containing cell cross-sectional area may be symmetrical or non-symmetrical. The cross-sectional area of the main fluid-containing cell and the side cells may be identical or different.

The angle between the main fluid-containing cell and the side cell may be 90 degrees or any other angle. One or more walls of the mixing apparatus may be smooth or have asperities. The fluid containing cell and side cell may have microscale dimensions or less. At least one pair of transverse side cells is necessary.

The secondary fluid flow may perturb flow in the main fluid containing cell in a variety of ways. For example, the secondary fluid flow may create recurrent circulating fluid flow within the fluid containing cell or cause laminar flow conditions in the fluid containing cell. The secondary fluid flow may be oscillatory, for example, vary in time or intensity, which oscillation may be applied by an external mechanism or an internal mechanism. The secondary fluid flow may introduce a fluid motivating shear into the transverse cell and or into the main cell.

Fluids may be reagents introduced individually, sequentially, or by pair in the main fluid containing cell. The introduction of reagents may be delayed in time. The introduction of at least one reagent may be downstream from the previous reagent introduction.

There are no limitations on the nature of the fluids that may be contained in the fluid containing cell. For example, the fluid may be a liquid or a gas. The fluid in the transverse cell may be identical, different or a mixture of one of the fluids in the main cell. Two or more fluids may be injected in the main fluid containing cell before the intersection with the side/intersecting cell.

The present invention may also comprise a system of one or more mixing apparatuses mounted in series or in parallel, so that one or more mixing processes may be performed in series or in parallel.

Consequently, the present invention discloses a method of a method of manipulating two or more fluids, comprising perturbing two or more fluid flows with one or more oscillating side flows, wherein the oscillating side flow causes the two or more fluid flows to homogeneously mix under laminar conditions and within 100 milliseconds.

### REFERENCES

The following references are incorporated by reference herein:
1. Dobson C. M. Protein folding and misfolding NATURE 426: 884 2003.
2. DeArmond, S. J., and Prusiner, S. B. 1997. Molecular neuropathology of prion diseases. In The molecular and genetic basis of neurological disease. R. N. Rosenberg, S. B. Prusiner, S. DiMauro, and R. L. Barchi, editors. Butterworth-Heinemann. Boston, Mass., USA. 145-163.
3. Selkoe, D. J. 2002. Deciphering the genesis and fate of amyloid-β protein yields novel therapies for Alzheimer disease. J. Clin. Invest.
4. Conway, K. A., Harper, J. D., and Lansbury, P. T. 2000. Fibrils formed in vitro from α-synuclein and two mutant forms linked to Parkinson's disease are typical amyloid. Biochemistry. 39:2552-2563.
5. Thomas, P. J., Qu, B. H. & Pedersen, P. L. Defective protein folding as a basis of human disease. Trends Biochem. Sci. 20, 456-459 (1995).
6. Fadiel A, Eichenbaum K D, Hamza A, et al. Modern pathology: Protein mis-folding and mis-processing in complex disease CURRENT PROTEIN & PEPTIDE SCIENCE 8 (1): 29-37 FEB 2007.
7. Bullock, A. N. & Fersht, A. R. Rescuing the functions of mutant p53. Nature Rev. Cancer 1, 68-76 (2001).
8. Prusiner, S. B. Proc. Natl. Acad. Sci. U.S.A. 1998, 95, 13363.
9. Kuwata, K.; Matumoto, T.; Cheng, H.; Nagayama, K.; James, T. L.; Roder, H. Proc. Natl. Acad. Sci. U.S.A. 2003, 100, 14790.
10. Horwich, A. Protein aggregation in disease: a role for folding intermediates forming specific multimeric interactions. J. Clin. Invest. 110, 1221-1232 (2002).
11. Aramayo R, Mérigoux C, Larquet E, Bron P, Pérez J, Dumas C, et al. Biochim Biophys Acta 2005; 1724:345.
12. Casselyn M, Tardieu A, Delacroix H, Finet S. Biophys J 2004; 87:2737.
13. Mayor, U., Johnson, C. M., Daggett, V. & Fersht, A. R. Protein folding and unfolding in microseconds to nanoseconds by experiment and simulation. Proc. Natl. Acad. Sci. USA 97, 13518-13522 (2000).
14. Snow, C. D., Nguyen, H., Pande, V. S. & Gruebele, M. Absolute comparison of simulated and experimental protein-folding dynamics. Nature 420, 102-106 (2002).
15. Shastry M C R, Roder H Evidence for barrier-limited protein folding kinetics on the microsecond time scale NATURE STRUCTURAL BIOLOGY 5 (5): 385-392 MAY 1998.
16. Chance B., J. Franklin Inst. 1940, 279, 613.
17. M Kakuta, P Hinsmann, A Manz, B Lendl, Time-resolved Fourier transform infrared spectrometry using a microfabricated continuous flow mixer: . . . . Lab Chip, 2003, 3, 82-85.
18. P. Panine, S. Finet, T. M. Weiss, T. Narayanan Probing fast kinetics in complex fluids by combined rapid mixing and small-angle X-ray scattering Advances in Colloid and Interface Science 127 (2006) 9-18.
19. V. Busico, R. Cipullo, V. Esposito, Stopped-flow polymerizations of ethene and propene in the presence of the catalyst system rac-Me₂Si(2-methyl-4-phenyl-1-indenyl)₂ZrCl₂/methylaluminoxane, Macromol. Rapid Commun. 1999, 20, 116
20. Taylor D J, Johnson J E. Protein Sci 2005; 14:401.
21. Elöve GA, Bhuyan A K, Roder H. Biochemistry Kinetic Mechanism of Cytochrome c Folding: Involvement of the Heme and Its Ligands 1994; 33:6925.
22. Bax, A. Multidimensional nuclear magnetic resonancemethods for protein studies. Curr. Opin. Struct. Biol. 4, 738-744 (1994).
23. Stodeman M, Schwarz F P. Anal Biochem Importance of product inhibition in the kinetics of the acylase hydrolysis reaction by differential stopped flow microcalorimetry 2002; 308:285.
24. Rahman MBBA, Bolton P R, Evans J, Dent A J, Harvey I, Diaz-Moreno S. Faraday Discuss 2003; 122:211.
25. Russell, R., Millett, I. S., Doniach, S. & Herschlag, D. (2000). Small angle X-ray scattering reveals a compact intermediate in RNA folding. Nature Struct. Biol. 7, 367-370.
26. A. Di Martino, J. P. Broyer, R. Spitz, G. Weickert, T. F. McKenna, A Rapid Quenched-Flow Device for the Characterisation of the Nascent Polymerisation of Ethylene under Industrial Conditions, Macromol. Rapid Commun. 2005, 26, 215-220.
27. Song F Q, Cannon R D, Bochmann M, Zirconocene-catalyzed propene polymerization: A quenched-flow kinetic study, J. AM. CHEM. SOC. 9 VOL. 125, NO. 25, 2003.
28. Elöve GA, Bhuyan A K, Roder H. Kinetic mechanism of cytochrome-C folding—involvement of the heme and its ligands, Biochemistry 1994; 33:6925.
29. Shastry M C R, S. D. Luck, Roder H, A Continuous-Flow Capillary Mixing Method to Monitor Reactions on the Microsecond Time Scale, Biophysical Journal Volume 74 May 1998 2714-2721.
30. Rhode H., Maki K and Cheng H, Early events in protein folding explored by rapid mixing methods, Chem. Rev. 2006, 106, 1836-1861.
31. F. Bottausci, I. Mezic, C. D. Meinhart and C. Cardonne Mixing in the shear superposition micromixer: three-dimensional analysis, 2005, Philos. T. Roy. Soc. A 362 (1818):1001-10018.
32. M. Volpert, I. Mezic, C. D. Meinhart and M. Dahleh, An actively controlled micromixer 1999 In Proc. ASME MEMS, Nashville, Tenn., pp. 483-487.
33. G. Mathew, I. Mezic and L. Petzold, Optimization of mixing in an active micromixing device 2005, Physica D 211(1-2) 23-46.
34. C. D. Meinhart, S. T. Wereley and J. G. Santiago, 1999 Measurements of a microchannel flow. Exp. Fluids 27, 414-419.
35. Stroock, A D., et al., Chaotic Mixer for Microchannels, “Science Magazine,” vol. 295, Jan. 25, 2002, The American Association for the Advancement of Science, Stanford University's HighWire Press, pp. 647-651.
36. Ho, C. M, Tabeling, P, Lee, Y. K, Deval, J. H. Micro chaotic mixer U.S. Pat. No. 6,902,313, Jun. 7, 2005.
37. Arnaud G, Glasgow I, Aubry N., Effects of microchannel geometry on pulsed flow mixing, Mech. Research. Communications 33 (5): 739-746 September-October 2006.
38. Song H., Tice J. D. & Ismagilov R. F. 2003 A Microfluidic System for Controlling Reaction Networks in Time Angew. InChem. Int. Ed, 42 No 7.
39. Bottausci F, Caroline C., Mezic I, Meinhart C D. An Ultrashort Mixing Length Micromixer: The Shear Superposition Micromixer, Lab on a Chip, 2007, volume 7, issue 3.
40. U.S. Pat. No. 7,129,091 Ismagilov et al. Oct. 31, 2006.
41. U.S. Pat. No. 6,900,021 Harrison et al. May 31, 2005.
42. U.S. Pat. No. 6,632,619 Harrison et al. Oct. 14, 2003.
43. U.S. Pat. No. 6,902,313 Ho et al. Jun. 7, 2005.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. An apparatus for mixing two or more fluids, comprising:
(a) a fluid containing cell for containing two or more main fluid flows;
(b) at least one side cell for introducing a secondary fluid flow into the fluid containing cell at an intersection between the side cell and the fluid containing cell, wherein the secondary fluid flow perturbs the main fluid flows in the fluid containing cell and introduces recirculating motion in the fluid containing cell.

2. The apparatus of claim 1, wherein the two or more fluids introduced into the fluid containing cell upstream of the intersection are not mixed, the secondary fluid flow creates a mixing of the two or more fluids, and two or more fluids are fully mixed downstream of the intersection.

3. The apparatus of claim 2, wherein the secondary fluid flow is an oscillatory flow resulting from fluid motion oscillations at specific amplitudes and frequencies driven in the side cell which perturbs the two or more main fluid flows in the fluid containing cell to enhance the mixing of the two or more fluids in the fluid containing cell.

5. The apparatus of claim 2, wherein the mixing is under laminar flow conditions.

6. The apparatus of claim 2, wherein the apparatus is a laminar flow mixer for one or more of the following applications:
(a) stopped flow mixing;
(b) quenched flow mixing;
(c) continuous flow mixing;
(d) ELISA testing;
(e) c-DNA experimentation; and
(f) Kinase-based assays.

7. The apparatus of claim 1, wherein there are a pair of side cells.

8. The mixing apparatus of claim 1, wherein the side cell is perpendicular to the fluid containing cell.

9. The mixing apparatus of claim 1, wherein a secondary fluid in the secondary fluid flow is identical to one of the fluids.

10. The mixing apparatus of claim 1, wherein a secondary fluid in the secondary fluid flow is a mixture of the fluids.

11. A method of manipulating two or more fluids, comprising:
(a) perturbing two or more fluid flows with one or more oscillating side flows, wherein the oscillating side flow causes the two or more fluid flows to homogeneously mix under laminar conditions and within 100 milliseconds.

12. The method of claim 11, wherein the oscillating side flow creates recurrent circulating flows within the two or more fluid flows.

13. The method of claim 11, wherein oscillating side flow is a jet flow having a frequency and amplitude of oscillation which enhances mixing by creating vortices, which in turn create multiple fluid layers, and Taylor-Aris dispersion in the two or more fluids flows.

14. The method of claim 11, wherein the mixing is used to perform one or more of the following: stopped flow analysis, quenched flow analysis or continuous flow analysis.

15. The method of claim 11, used to perform ELISA testing or c-DNA experimentation.

16. The method of claim 11, wherein the mixing is fast enough to observe protein folding and unfolding.

17. A device for implementing the method of claim 11.

18. An apparatus for mixing two or more fluids, comprising:
a main channel for containing a first fluid stream of a first fluid and a second fluid stream of a second fluid, in the main channel;
a secondary channel for introducing a transverse oscillating jet flow into the main channel at an intersection between the secondary channel and the main channel, wherein the intersection provides an intersection for the first fluid stream, second fluid stream, and the transverse oscillating jet flow;
a first inlet to the main channel, upstream of the intersection, for introducing the first fluid into the main channel;
a second inlet to the main channel, upstream of the intersection, for introducing the second fluid into the main channel; and
an outlet for the main channel, downstream of the intersection.

19. The apparatus of claim 18, wherein the main channel has a length which is at least ten times h where h=100 μm.

20. The apparatus of claim 18, wherein the dimensions of the secondary channel are chosen so that flow in the secondary channel has a Reynolds number greater than 11, and the transverse oscillating jet flow has an amplitude and frequency of oscillation causing a mixing variance coefficient less than 0.02.
